(19) United States
(12) Patent Application Publication
(10) Pub. No.: US 2021/0103280 A1
(43) Pub. Date: Apr. 8, 2021

(54) Autonomous Road Surface Marking Vehicle

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/593,036

(22) Filed: Oct. 4, 2019

(51) Int. Cl. G05D 1/00; G05D 1/02; E01C 23/22; E01C 23/18

(52) U.S. Cl. CPC G05D 1/0088; G05D 1/0214; G05D 1/0295; G05D 1/0278; G05D 1/0251; G05D 1/0257; G05D 2201/0213; G05D 1/0289; G05D 1/028; G05D 1/0293; E01C 23/22; E01C 23/18; G05D 1/0242

(57) ABSTRACT

This invention pertains to the development of an autonomous road surface marking vehicle that is capable of detecting road, pedestrians, cars, and other road obstacles and in which these autonomous vehicles provide several types of functionalities such as painting different lines, adding markers, removing markers, warning other traffic, etc. The autonomous road surface marking vehicle is designed to follow routes and mark road surfaces and comprises an autonomous vehicle that includes a drive by wire kit, a database sorting the routes, locations, and types of markings, a mechanism for detecting the road, pedestrians, cars, and other road obstacles, and a control system that control the autonomous vehicle to follow routes and operate the road surface marking device at the proper location.

### CROSS-REFERENCES TO OTHER APPLICATIONS

None.

### STATEMENT REGARDING FEDERAL SPONSORSHIP

No part of this invention was a result of any federally sponsored research.

### FIELD OF THE INVENTION

This invention pertains to the development of autonomous road surface marking vehicle that is designed to paint different lines, add and remove markers, warn other traffic, and other types of functions.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

The statements in this section merely provide background information related to the present disclosure and may not constitute prior art.

Vehicle convoys are used in a variety of endeavors including agriculture, construction, earth moving, and military operations. Military convoying is an inherently dangerous application. Implicit to the task of convoy is the danger of attack by enemy forces. Despite the dangers, convoying is a required operation that enables day-to-day military operations in war-torn regions. Convoy Soldiers are exposed to extreme dangers with the threat of roadside attacks, mines and improvised explosive devices (IEDs). In a known convoy operation, a manned lead vehicle positioned at the head of a vehicle convoy is followed by unmanned follower vehicles in the convoy. The operation of the follower vehicles in this leader-follower arrangement is controlled based on information transmitted to it from the leader vehicle at the head of the convoy. The follower vehicles have no decision-making capability.

Autonomous leader-follower military convoy operations are also known. To cut costs, a common practice is to endow the lead vehicle with a highly accurate pose system, then track the lead vehicle using sensor-based tracking technique such as through radar, camera, or LIDAR. This reduces cost because the follower vehicles have less expensive sensors compared to the relatively expensive inertial measurement units (IMUs) required for highly accurate pose estimation. The vehicle at the head of the convoy, however, is particularly vulnerable to hostile attacks. In the event that the lead vehicle is compromised somehow (taken over, or destroyed), the follower vehicles are helpless to take over.

There have not been any reports of the development of an autonomous road surface marking vehicle that is designed to paint different lines, add and remove markers, and warn other traffic.

### SUMMARY OF THE INVENTION

The present invention involves the development of a road surface marking vehicle that is designed to perform various functionalities such as painting different lines, adding and removing markers, and warning other traffic.

The road surface marking vehicle is capable of detecting the road, pedestrians, cars, and other road obstacles.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Overall schematic of the basic system of the autonomous road surface marking vehicle.

FIG. 2—Different types of vehicles are present and multiple vehicles can convoy and the lead vehicle can be functional or simply a leader vehicle and this vehicle could also be a smaller vehicle that does not require a CDL license.

FIG. 3—FIG. 3A shows the case where there are no obstacles present and the road surface marking vehicle follows the predetermined routes while marking. FIG. 3B shows the case where if there are obstacles that block the path, the road surface marking vehicle may either stop and wait until the obstacle is clear or stop the marking operation while it drives around.

FIG. 4—This illustrates regions where certain types of markings are not allowed in different places in the road. A marking database may specify where various operations can be performed, and at which settings. In the diagram, there are regions where there are no limitations on the type of road surface markings that can be placed, places where Botts' Dots should be placed, places where no rumble strips should be placed and places where no rumble strips and no cat's eyes should be placed.

FIG. 5—This figure illustrates that the different trucks can communicate with each other using radios or other methods and the vehicle location and speed are shared and the location, obstacles, and road conditions information are shared between the vehicles. Also, information on driving, marking, and other status can be shared between the vehicles.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

An autonomous road surface marking vehicle that is designed to follow routes and mark road surfaces which is comprised of an autonomous vehicle that includes a drive by wire kit, a database storing the routes, locations, and types of markings, a mechanism for detecting the road, pedestrians, cars, and other road obstacles, and a control system that controls the autonomous vehicle to follow routes and operate the road surface marking device at the proper location has been developed.

The autonomous road surface marking vehicle has multiple autonomous vehicles that are convoyed to provide additional functionalities such as painting different lines, adding and removing markers, and warning other traffic.

The autonomous road surface marking vehicle or vehicles follow a leader autonomous vehicle that is either manned or unmanned rather than following the stored routes.

The first autonomous vehicle of the convoy is a manned vehicle and this vehicle may be a smaller autonomous vehicle that does not require a CDL license.

The autonomous road surface marking vehicle is equipped with sensors that detect if there is an obstacle on the route and if the route is blocked, the system controller either stops the vehicle and the marking equipment while the obstacle is removed, or stops the marking operation while the vehicle drives around the obstacle.

In the autonomous road surface marking vehicle, the controller is aware of the rules of the road and the autonomous road surface marking vehicle automatically obeys the rules of the road.

The location of the road features is sensed using GPS or ranging radios, or LADAR, or stereo vision, or via EO or IR camera.

GPS is also referred to as global positioning system and it is a satellite-based navigation system that is made up of at least 24 satellites. GPS works in any weather conditions, anywhere in the world, 24 hours a day, with no subscription fees or setup charges. The U.S. Department of Defense (USDOD) originally put the satellites into orbit for military use, but they were made available for civilian use in the 1980s. GPS satellites circle the Earth twice a day in a precise orbit. Each satellite transmits a unique signal and orbital parameters that allow GPS devices to decode and compute the precise location of the satellite. GPS receivers use this information and trilateration to calculate a user's exact location. Essentially, the GPS receiver measures the distance to each satellite y the amount of time it takes to receive a transmitted signal.

Ranging radios refers to a system of radio transmitting stations, each of which transmits a signal that not only carries identification but also is of intrinsic value to a navigator in fixing his position.

LADAR, which is also referred to as Laser Detection and Ranging systems, is a surveying method that measures distance to a target by illuminating the target with laser light and measuring the reflected light with a sensor. Differences in laser return times and wavelengths can then be used to make digital 3-D representations of the target.

Computer stereo vision involves the extraction of 3D information from digital images, such as those obtained by a CCD camera. By comparing information about a scene from two vantage points, 3D information can be extracted by examining the relative positions of objects in the two panels.

EO camera refers to electro-optical camera. An optical sensor converts light rays into electronic signals. It measures the physical quantity of light and then translates it into a form that is readable by an instrument. An optical sensor is generally part of a larger system that integrates a source of light, a measuring device and the optical sensor.

IR camera refers to infrared camera. Here, infrared cameras photograph heat rather than objects. The camera is a heat-sensor that registers different temperature levels and converts them into a film or video image. Most cameras use digital imaging, but some use chemical infrared film.

The road surface marking functionality of the autonomous road surface marking vehicle is halted at particular locations. In an example, the rumble strips would not be applied near manhole covers, or cat's eyes would not be installed near sensitive drainage areas.

In the autonomous road surface marking vehicle, the control system on the second and other autonomous vehicles in the convoy have a reduced set of sensors, assuming that the first vehicle in the autonomous convoy is performing the obstacle and curb detection.

In the case of the autonomous road surface marking vehicle, the different autonomous vehicles in the convoy have a communication system that allows them to relay their position and use this position to maintain overall convoy speed.

The autonomous road surface marking vehicles in the convoy maintain separation distances using a direct measurement of these distances with uwb ranging radios, ladar, laser measurement, ultrasonics, stereo vision, or structured light.

Ultra-wideband (also known as UWB, ultra-wide band and ultraband) is a radio technology that can use a very low energy level for short-range, high-bandwidth communications over a large portion of the radio spectrum. UWB has traditional applications in non-cooperative radar imaging.

A laser distance meter sends a pulse of laser light to the target and measures the time it takes for the reflection to return. For distances up to 30 m, the accuracy is 3 mm. On-board processing allows the device to add, subtract, calculate areas and volumes and to triangulate. You can measure distances at a distance.

Ultrasound is sound waves with frequencies higher than the upper audible limit of human hearing. Ultrasound is not different from “normal” sound in its physical properties, except that humans cannot hear it. This limit varies from person to person and is approximately 20 kilohertz in healthy young adults. Ultrasonics is the science and applications of ultrasonic waves.

Structured light is the process of projecting a known pattern (often grids or horizontal bars) on to a scene. The way that these deform when striking surfaces allows vision systems to calculate the depth and surface information of the objects in the scene, as used in structured light 3D scanners.

In the autonomous road surface marking vehicle, the controller either senses or has stored in the database a list of areas that should not be marked because they may cause damage to the line marking device. These types of areas include manhole covers, potholes, etc.

One of the autonomous road surface marking vehicles in the convoy can detect road conditions and road features such as the location of a pothole and relay the information to the other vehicles.

The last and/or first vehicle in the autonomous road surface marking vehicles in the autonomous convoy is not a road surface marking vehicle, but actually a signaling vehicle to signal to the traffic the road surface marking operations.

The control system of the autonomous road surface marking vehicle adjusts marking equipment operational parameters according to pavement conditions and environmental factors.

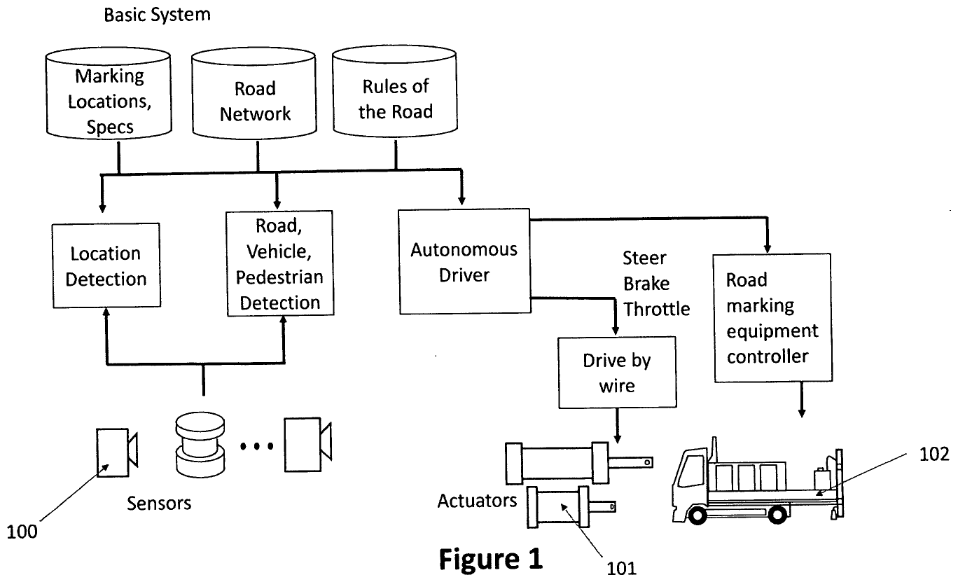

As shown in FIG. 1, the sensors (100) detect the location, the road, vehicle, and pedestrians and gathers information from the databases having the marking locations, specs, road network, and the rules of the road. This information is then passed on to the autonomous driver in which there is steer brake, and throttle by the drive by wire kit which lead to the actuators (101). The autonomous driver is linked to the road marking equipment controller which leads to the autonomous road surface marking vehicle (102).

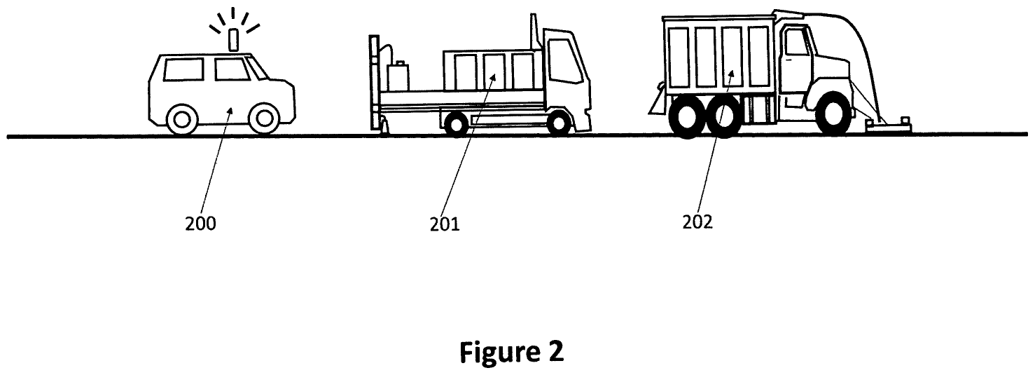

FIG. 2 shows a convoy of multiple autonomous road surface marking vehicles (200, 201, 202) that are of different types and functions. The lead vehicle (200) can be either autonomous or driven by humans. Also, the leader vehicle (200) can function simply as a leader vehicle (200) in which it is unfunctional or it can be an actual functional vehicle. In addition, the lead vehicle (200) could be a smaller vehicle that does not require a CDL license to operate.

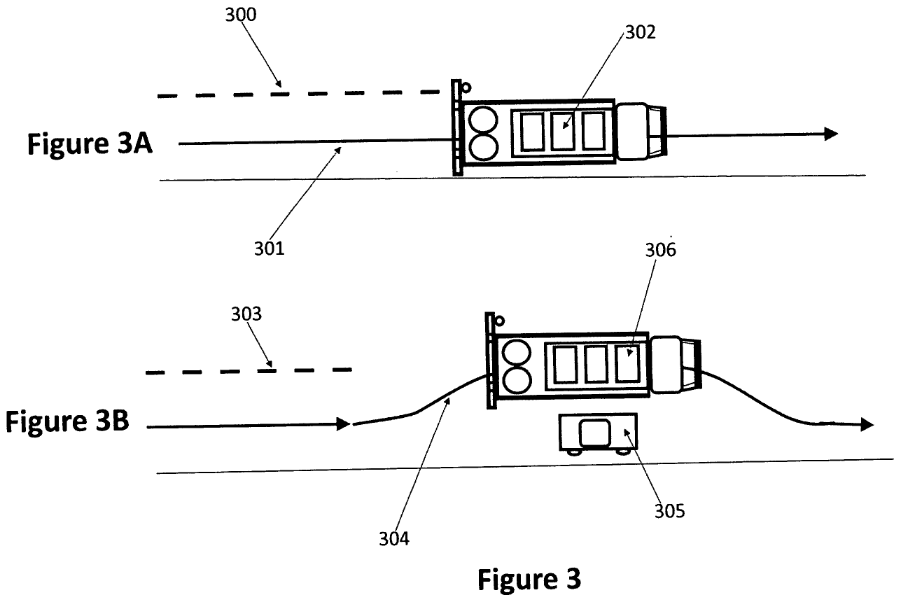

FIG. 3A shows that the autonomous road surface marking vehicle may follow predetermined routes (301) while marking in the case where obstacles are not present. The marks (300) that are made can be seen in the figure. FIG. 3B shows that the autonomous road surface marking vehicle (306) may either stop and wait until the obstacle (305) is clear or stop the marking operation while it drives around the obstacle (305). The vehicle follows a modified path (304) in the process. The marks (303) that are made can be seen in the figure.

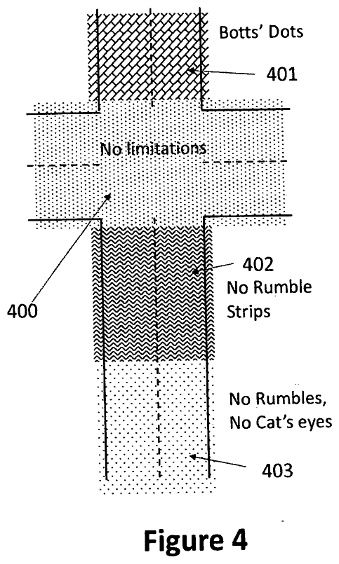

FIG. 4 illustrates different regions in the road where different types of markings can be placed. Here, there are some places with no limitations (400) on the types of markings that can be placed, some places with Botts' Dots (401), some places with no rumble strips (402), and some places with no rumbles and no cat's eyes (403). There is a marking database that specifies where various operations can be performed, and at which settings.

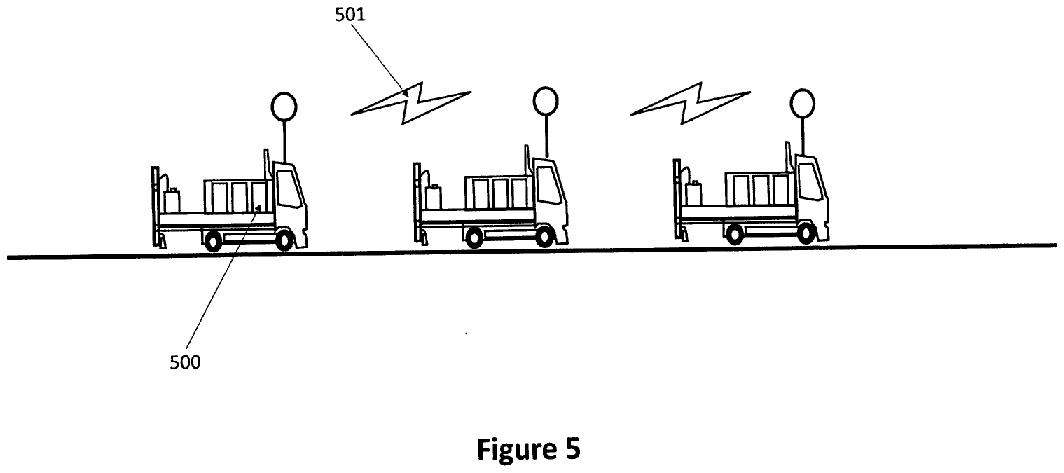

FIG. 5 shows the autonomous road surface marking vehicles (500) in the convoy communicating with each other using radios or other methods. The communication pathway (501) is illustrated in the figure. The autonomous road surface marking vehicles (500) share information on the vehicle location and speed to help maintain overall convoy formation and speed. Also, information sensed by the lead vehicle is shared with the following vehicles and the kind of information that is shared includes the location, obstacles, and road conditions. In addition, driving, marking, and other status can be shared between the autonomous road surface marking vehicles (500).

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

The embodiments of the invention in which an exclusive property or privilege is claimed are defined as follows:

1. An autonomous road surface marking vehicle designed to follow routes and mark road surfaces comprising:
an autonomous vehicle that includes a drive by wire kit;
a database storing the routes, locations, and types of markings;
a mechanism for detecting the road, pedestrians, cars and other road obstacles;
a control system that controls the autonomous vehicle to follow routes and operate the road surface marking device at the proper locations.

2. The autonomous road surface marking vehicle of claim 1 wherein multiple autonomous vehicles are convoyed to provide additional functionalities (painting different lines, adding markers, removing markers, warning other traffic, etc.).

3. The autonomous road surface marking vehicle of claim 1 wherein the autonomous vehicle or vehicles follow a leader autonomous vehicle that is either manned or unmanned rather than following the stored routes.

4. The autonomous road surface marking vehicle of claim 1 wherein if the first autonomous vehicle of the convoy is a manned vehicle, this vehicle may be a smaller autonomous vehicle that does not require a CDL license.

5. The autonomous road surface marking vehicle of claim 1 wherein the autonomous road surface marking vehicle is equipped with sensors that detect if there is an obstacle on the route and if the route is blocked, the system controller either stops the vehicle and the marking equipment while the obstacle is removed, or stops the marking operation while the vehicle drives around the obstacle.

6. The autonomous road surface marking vehicle of claim 1 wherein the controller is aware of the rules of the road and the autonomous road surface marking vehicle automatically obeys the rules of the road.

7. The autonomous road surface marking vehicle of claim 1 wherein the location of the road features is sensed using GPS or ranging radios, or LADAR, or stereo vision, or is detected using an EO or IR camera.

8. The autonomous road surface marking vehicle of claim 1 wherein the road surface marking functionality is halted at particular locations. For example, rumble strips would not be applied near manhole covers, or cat's eyes would not be installed near sensitive drainage areas.

9. The autonomous road surface marking vehicle of claim 1 wherein the control system on the second and other autonomous vehicles in the convoy have a reduced set of sensors, assuming that the first vehicle in the autonomous convoy is performing the obstacle and curb detection.

10. The autonomous road surface marking vehicle of claim 1 wherein the different autonomous vehicles in the convoy have a communication system that allows them to relay their position and use this position to maintain overall convoy speed.

11. The autonomous road surface marking vehicle of claim 1 wherein the autonomous vehicles in the convoy maintain separation distances using a direct measurement of these distances with uwb ranging radios, ladar, laser measurement, ultrasonics, stereo vision, or structured light.

12. The autonomous road surface marking vehicle of claim 1 wherein the controller either senses or has stored in the database a list of areas that should not be marked because they may cause damage to the line marking device: manhole covers, potholes, etc.

13. The autonomous road surface marking vehicle of claim 1 wherein one of the autonomous vehicles in the convoy can detect road conditions and road features, e.g. location of a pothole, and relay the information to the other vehicles.

14. The autonomous road surface marking vehicle in claim 1 wherein the last and/or first vehicle in the autonomous convoy is not a road surface marking vehicle, but a signaling vehicle to signal to the traffic the road surface marking operations.

15. The autonomous road surface marking vehicle in claim 1 wherein the control system adjusts marking equipment operational parameters according to pavement conditions and environmental factors.
